(19) United States
(12) Patent Application Publication
(10) Pub. No.: US 2020/0009010 A1
(43) Pub. Date: Jan. 9, 2020

(54) TAPPING DEVICE

(71) Applicant: L'Oreal, Paris (FR)

(72) Inventors: Woo Ram Park, Kawasaki-shi, Kanagawa (JP); Bradford Pistorio, Kawasaki-shi, Kanagawa (JP); Helio Ito, Kawasaki-shi, Kanagawa (JP)

(73) Assignee: L'Oreal, Paris (FR)

(21) Appl. No.: 16/315,964

(22) PCT Filed: May 10, 2017
(86) PCT No.: PCT/JP2017/018432

§ 371 Date: Jan. 7, 2019

(30) Foreign Application Priority Data
Jul. 13, 2016 (JP) 2016-138291

(51) Int. Cl. A61H 23/00; A61H 39/00

(52) U.S. Cl. CPC A61H 23/006; A61H 39/002; A61H 2201/5028; A61H 2201/1418; A61H 2201/5005; A61H 2201/149

(57) ABSTRACT

To provide a tapping device, capable of making a more comfortable tapping motion. A tapping device for vertically tapping a skin surface comprising: a tapping applicator for applying a normal force on the skin surface, wherein the tapping applicator is reciprocated in a direction perpendicular to the skin surface; an actuator for generating the linear reciprocating motion of the tapping applicator, wherein the actuator comprises a direct-current motor which is driven at an applied magnitude of voltage; a pressure sensing mechanism for measuring the magnitude of normal pressure exerted on the actuator during the operation of the tapping device in real time; and a controller for controlling the magnitude of voltage to be applied to the direct-current motor in real time, wherein the applied magnitude of voltage corresponds to the magnitude of normal pressure measured by the pressure sensing mechanism.

### TECHNICAL FIELD

The present invention relates to a tapping device; and, more particularly, to an improved method for making a more comfortable tapping motion of the tapping device.

### BACKGROUND ART

Cosmetic devices have many purposes, but one of their major roles is helping beauty treatment. A tapping motion is not only a simple but effective means for the penetration of a skin care product, but also a necessary treatment for various makeup products. In professional make up, a makeup artist works hard tapping formula to make the product more stable on the skin and to improve the absorption of the skincare product.

Conventionally, various kinds of cosmetic tapping devices have been proposed for giving a tapping motion to the skin. For example, in a vibration cosmetic container disclosed in PCT International Publication No. WO 2014/021570, as moving parts for applying vibration pressure to a face, a vibration motor and a mechanical structure are provided. In the vibration cosmetic container, a current sensor is further provided for the circuit of the vibration motor to check the amount of current supplied to the vibration motor, and the vibration motor is controlled based on the amount of current supplied to the vibration motor.

The requirements for conventional cosmetic tapping devices include giving a more comfortable tapping motion. However, with the conventional technology, it has been difficult for tapping devices to meet these requirements.

### DISCLOSURE OF THE INVENTION

Through extensive investigation of this problem, the inventor realized that the following points are very important.

The tapping motion can be created by a direct-current (DC) motor and mechanical structure such as cam structure, but the problem is that it is very difficult make the motion comfortable without a high level of noise and strong vibration. In order to make an appropriate tapping motion, an even tapping is one of the most important factors for all edges of the face, but it was difficult before. The torque of the direct-current motor is proportional with the rotation speed of the direct-current motor, but high speed makes higher noise and vibration. Therefore, the key to the noise, vibration, and harshness control is to give an adequate amount of power to the direct-current motor for a given pressure, and keep the speed of the direct-current motor uniform during the operation. From 500 rpm to 3,000 rpm is appropriate for tapping devices, but it was difficult to have enough torque in order to make smooth operation on the face.

A cam structure requires a physical contact between the rotational wheel and the shaft, and the stress and friction of this contact point causes noise and vibration. This is a typical problem with the cam structure which results in the mechanical stress at the contact point. The noise and vibration can be reduced at a low speed of rotation, but it is very hard to have appropriate power beyond the mechanical load at low speeds, since the torque of the motor may also be slightly decreased at a low speed. For a tapping device on the face, it should be flexible to move on an uneven face surface, but be able to tap evenly in various normal pressure situations. To achieve this, a more sensitive motion is required to deliver good, even application for the user.

Through extensive investigation of these problems, the inventor realized the present invention by finding that a more comfortable tapping motion during the operation of the tapping device can be achieved by measuring the magnitude of normal pressure exerted on the actuator during the operation of the tapping device in real time, and by modulating the magnitude of voltage applied to the direct-current motor based on the measured magnitude of normal pressure.

To achieve the above-mentioned object, the tapping device in accordance with the present invention is a tapping device for vertically tapping a skin surface comprising: a tapping applicator for applying a normal force on the skin surface, wherein the tapping applicator is reciprocated in a direction perpendicular to the skin surface; an actuator for generating the linear reciprocating motion of the tapping applicator, wherein the actuator comprises a direct-current motor which is driven at an applied magnitude of voltage; a pressure sensing mechanism for measuring the magnitude of normal pressure exerted on the actuator during the operation of the tapping device in real time; and a controller for controlling the magnitude of voltage to be applied to the direct-current motor in real time, wherein the magnitude of voltage corresponding to, preferably proportional with, the magnitude of normal pressure measured by the pressure sensing mechanism.

In the present invention, the skin surface may be a face surface. In the present invention, the direct-current motor may be driven at the rotational speed which is proportional with the applied magnitude of voltage.

<Pressure>

In the present invention, “normal pressure exerted on the actuator during the operation of the tapping device” may be a load (force) in which a reaction from a skin face side is applied to the actuator through the tapping applicator.

<Low Speed>

Preferably, in the present invention, the controller controls the rotational speed of the direct-current motor such that the rotational speed of the direct-current motor is kept between 500 rpm to 3,000 rpm during the operation of the tapping device.

<Movable Actuator>

Preferably, in the present invention, the tap device further comprises a case for housing the actuator and the pressure sensing mechanism. The actuator and the pressure sensing mechanism are vertically placed face to face with each other in the case, such that the actuator is relatively displaceable (movable) in the case in the vertical direction, in response to the normal pressure exerted on the actuator in the case during the operation of the tapping device.

<Flexible Switch>

Preferably, in the present invention, the pressure sensing mechanism comprises a flexible switch and a touch sensor array. The flexible switch is attached to the actuator so as to be relatively displaceable together with the actuator. The touch sensor array is attached to the case. The flexible switch and the touch sensor array are vertically placed face to face with each other in the case, such that the flexible switch and the actuator approach each other or move away from each other in response to the normal pressure exerted on the actuator during the operation of the tapping device.

The flexible switch makes contact with the touch sensor array such that the magnitude of the contact area between the flexible switch and the touch sensor array corresponds to, and is preferably proportional with, the magnitude of normal pressure exerted on the actuator during the operation of the tapping device.

The controller determines the magnitude of voltage to be applied to the direct-current motor based on the information about the magnitude of the contact area obtained by the touch sensor array, wherein the magnitude of the voltage corresponds to the magnitude of normal pressure exerted on the actuator during the operation of the tapping device, and the controller applies the determined magnitude of voltage to the direct-current motor.

In the present invention, the touch sensor array may be attached to the actuator so as to be relatively displaceable (movable) together with the actuator, and the flexible switch may be attached to the case. In the case of the touch sensor array is attached to the actuator, the touch sensor array may be vertically displaceable (movable) together with the actuator, relative to the flexible switch attached to the inner wall of the case.

<Dome-Shaped Flexible Switch>

Preferably, in the present invention, the flexible switch is a dome-shaped flexible switch, more preferably a solid dome-shaped flexible switch. The dome-shaped flexible switch makes an elastic deformation such that the magnitude of the contact area between the dome-shaped flexible switch and the sensor corresponds to, and is more preferably proportional with, the magnitude of normal pressure exerted on the actuator during the operation of the tapping device.

<Piezo Sensor>

Preferably, in the present invention, the pressure sensing mechanism comprises a pressure sensor. The pressure sensor is pushed by the actuator in response to the normal pressure exerted on the actuator during the operation of the tapping device.

More preferably, in the present invention, the pressure sensor comprises a piezo sensor. In the present invention, the piezo sensor generates a voltage having a magnitude which is proportional with the magnitude of pressure when the piezo sensor is pressed by the actuator.

In the present invention, the pressure sensor may be attached to the actuator or the case. In a case of the pressure sensor is attached to the actuator, the pressure sensor may be vertically displaceable (movable) together with the actuator, relative to the inner wall of the case.

<Conductive Material>

Preferably, in the present invention, the sensor comprises a conductive material body which elastically deforms, and an extractor. The conductive material body is pushed by the actuator in response to the pressure exerted on the actuator during the operation of the tapping device, and the conductive material body elastically deforms such that the magnitude of density of the conductive material body correspond to, and is more preferably proportional with, the magnitude of pressure exerted on the actuator during the operation of the tapping device. The extractor obtains the information about the magnitude of density of the conductive material body. The controller determines the magnitude of voltage to be applied to the direct-current motor based on the information about the magnitude of density obtained by the extractor. The controller applies the determined magnitude of voltage to the direct-current motor.

More preferably, in the present invention, the conductive material body is a conductive sponge or a conductive microgel rubber. The conductive sponge may be a sponge in which carbons are dispersed. The conductive microgel rubber may be a microgel rubber in which carbons are dispersed.

In the present invention, the conductive material body may be attached to the actuator or the case. In the case of the conductive material body is attached to the actuator, the conductive material body is vertically displaceable (movable) together with the actuator, relative to the inner wall of the case.

<Cam Structure>

Preferably, in the present invention, the actuator further comprises a cam structure. The tapping device further comprises a connecting shaft which is provided between the tapping applicator and the cam structure, such that the rotational motion of the direct-current motor is converted into the linear reciprocating motion of the connecting shaft via the cam structure.

<Advantages of the Present Invention>

In the present invention, a pressure sensing mechanism for measuring a normal pressure exerted on the actuator during the operation of the tapping device in real time is provided. Therefore, accurate information about the pressure exerted on the actuator can be obtained in real time. In the present invention, a controller for applying the voltage to the direct-current motor based on the measured pressure by the pressure sensing mechanism is provided. Therefore, in the present invention, a more comfortable tapping motion can be provided, compared with the conventional tapping device.

### BRIEF DESCRIPTION OF THE DRAWINGS

FIG. 1 is an explanatory view of a schematic configuration of a tapping device in accordance with a first embodiment of the present invention;

FIGS. 2A and 2B are explanatory views of a pressure sensing mechanism of the tapping device shown in FIG. 1;

FIG. 3 is an explanatory view of a controlling process for the tapping device shown in FIG. 1;

FIG. 4 is an explanatory view of a schematic configuration of a tapping device in accordance with a second embodiment of the present invention;

FIG. 5 is an explanatory view of a pressure sensing mechanism of the tapping device shown in FIG. 4;

FIG. 6 is an explanatory view of a controlling process for the tapping device shown in FIG. 4;

FIG. 7 is an explanatory view of a schematic configuration of a cosmetic tapping device in accordance with a third embodiment of the present invention;

FIGS. 8A and 8B are explanatory views of a pressure sensing mechanism of the tapping device shown in FIG. 7; and

FIG. 9 is an explanatory view of a schematic configuration of a cam structure which can be used in the tapping devices in accordance with the embodiments of the present invention.

### DETAILED DESCRIPTION OF THE INVENTION

Embodiments of the present invention will be described below by referring to the drawings.

### First Embodiment

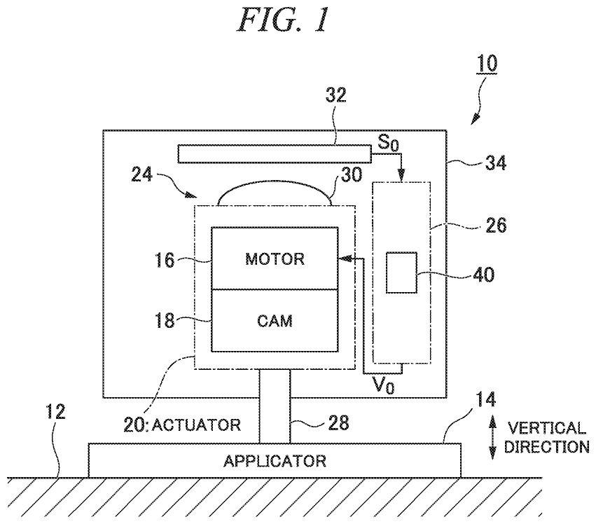

FIG. 1 shows an explanatory view of a schematic configuration of a tapping device in accordance with a first embodiment of the present invention. The tapping device 10 shown in FIG. 1 is a cosmetic tapping device for vertically tapping a skin surface 12 such as a face surface. In an embodiment, the tapping device 10 includes a tapping applicator 14 for applying a normal force on the skin surface 12. In an embodiment, the normal force is the component of the contact force exerted on an object (e.g., a person) that is substantially perpendicular to the surface (surface being a plane) of contact. In an embodiment, the tapping device 10 includes a tapping applicator 14 for applying a normal force along a vertical direction from the bottom of the tapping applicator 14 to the surface skin surface 12.

The tapping device 10 comprises: a tapping applicator 14 for applying a normal force on the skin surface 12, wherein the tapping applicator 14 is reciprocated in a direction perpendicular to the skin surface; an actuator 20 for generating the linear reciprocating motion of the tapping applicator 14, wherein the actuator 20 comprises a direct-current motor 16 and a cam structure 18, and wherein the direct-current motor 16 is driven at the magnitude of voltage applied to the direct-current motor 16; a pressure sensing mechanism 24 for measuring the magnitude of normal pressure exerted on the actuator 20 during the operation of the tapping device 10 in real time; a controller 26 for controlling the magnitude of voltage to be applied to the direct-current motor 16 in real time, wherein the applied magnitude of voltage is proportional with the magnitude of normal pressure measured by the pressure sensing mechanism 24; and a connecting shaft 28.

The present invention has a feature that the magnitude of normal pressure exerted on the actuator during the operation of the tapping device is measured by the pressure sensing mechanism in real time, and the magnitude of voltage corresponding to the measured magnitude of normal pressure is applied to the direct-current motor by the controller. In an embodiment, the normal pressure is the component of the contact pressured exerted on an object (e.g., an actuator) that is substantially perpendicular to the surface (surface being a plane) of contact.

In the present embodiment, therefore, a solid dome-shaped flexible switch 30 and a touch sensor array 32 are provided as the pressure sensing mechanism.

Moreover, in the present embodiment, the tapping device 10 comprises an outer case 34 for housing the actuator 20, the dome-shaped flexible switch 30, and the touch sensor array 32.

The dome-shaped flexible switch 30 is fixed at the upper end of the actuator 20 such that the dome-shaped flexible switch 30 is movable together with the actuator 20 in the outer case 34. The touch sensor array 32 is fixed at the inner wall of the outer case 34. The dome-shaped flexible switch 30 and the touch sensor array 32 are vertically placed face to face with each other in the outer case 34.

Accordingly, when the actuator 20 is relatively displaced in response to the normal pressure exerted on the actuator 20 during the operation of the tapping device 10, the dome-shaped flexible switch 30 is displaced together with the actuator 20. Whereby the dome-shaped flexible switch 30 and the touch sensor array 32 approach each other or move away from each other in response to the normal pressure exerted on the actuator 20 during the operation of the tapping device 10.

When the dome-shaped flexible switch 30 makes contact with the touch sensor array 32, the dome-shaped flexible switch 30 elastically deforms such that the magnitude of the contact area between the dome-shaped flexible switch 30 and the touch sensor array 32 is proportional with the magnitude of normal pressure exerted on the actuator 20 during the operation of the tapping device 10.

The touch sensor array 32 measures the magnitude of the contact area between the dome-shaped flexible switch 30 and outputs a signal including the information about the measured magnitude of contact area.

The controller 26 determines the magnitude of voltage to be applied to the direct-current motor 16 based on the information about the magnitude of the contact area obtained by the touch sensor array 32.

The controller 26 is provided with an electric battery 40 for supplying an electrical power to the direct-current motor 16.

The direct-current motor 16 is driven at the applied magnitude of voltage. In the present embodiment, the controller 26 controls the rotational speed of the direct-current motor 16 such that the rotational speed of the direct-current motor 16 is kept at a low speed, preferably between 500 rpm to 3,000 rpm during the operation of the tapping device 10.

As mentioned above, in the present embodiment, the magnitude of the pressure exerted on the actuator 20 is measured by the dome-shaped flexible switch 30 and the touch sensor array 32 during the operation of the tapping device 10 in real time, and the direct-current motor 16 is driven at the magnitude of voltage which is proportional with the measured magnitude of the pressure exerted on the actuator 20. Therefore, compared with conventional tapping devices, in the present embodiment, a more comfortable tapping motion during the operation of the tapping device 10 can be achieved.

<Pressure Sensing Mechanism>

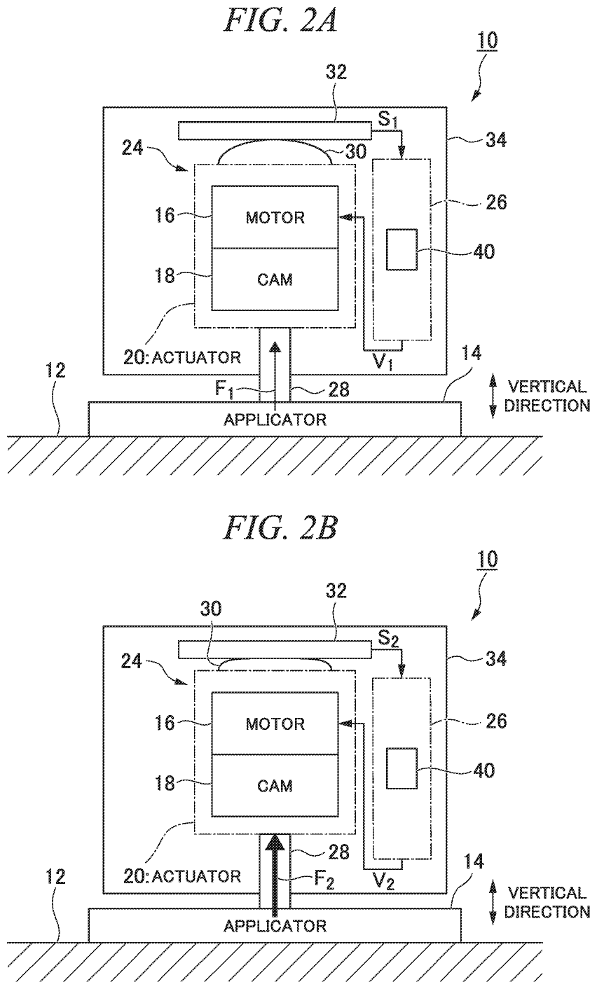

The pressure sensing mechanism of the present embodiment will be described in detail below by referring to FIGS. 2A and 2B.

As shown in FIG. 2A, when a user slightly pushes down the outer case 34 of the tapping device 10 against the skin surface 12 during the operation of the tapping device 10, a load (pressure) F₁ from the skin face 12 side is applied to the actuator 20 through the tapping applicator 14, the connecting shaft 28, and the cam structure 18 and eventually slightly presses the touch sensor array 32 with the dome-shaped flexible dome switch 30. In FIG. 2A, the actuator 20 is upwardly displaced in the outer case 34 in response to the normal pressure acting on the actuator 20 during the operation of the tapping device 10, and the dome-shaped flexible switch 30 makes contact with the touch sensor array 32.

Under a low load condition as shown in FIG. 2A, the dome-shaped flexible switch 30 is elastically deformed such that the magnitude A₁ of the contact area between the dome-shaped flexible switch 30 and the touch sensor array 32 is proportional with the magnitude F₁ of the normal pressure exerted on the actuator 20 during the operation of the tapping device 10.

Accordingly, the touch sensor array 32 outputs a signal S₁ including the information about the magnitude A₁ of the contact area, wherein the magnitude A₁ of the contact area is proportional with the magnitude F₁ of the pressure exerted on the actuator 20 during the operation of the tapping device 10.

The controller 26 determines the magnitude V₁ of voltage to be applied to the direct-current motor 16 based on the information about the magnitude A₁ of the contact area obtained by the touch sensor array 32. The determined magnitude V₁ of voltage is proportional with the magnitude F₁ of the normal pressure exerted on the actuator 20 during the operation of the tapping device 10. The controller 26 applies the determined magnitude V₁ of voltage to the direct-current motor 16.

As a result, the direct-current motor 16 is driven at the applied magnitude V₁ of voltage. Accordingly, under the load condition shown in FIG. 2A, more power is given to the direct-current motor 16, compared with a case under a load condition shown in FIG. 1.

As shown in FIG. 2B, when the user strongly pushes down the outer case 34 of the tapping device 10 against the skin surface 12 during the operation of the tapping device 10, a load (force) F₂ (F₂>F₁) from the skin surface 12 side is applied to the actuator 20 through the tapping applicator 14, the connecting shaft 28, and the cam structure 18, and eventually strongly presses up the touch sensor array 32 with the dome-shaped flexible switch 30.

Under a higher load condition as shown in FIG. 2B, the dome-shaped flexible switch 30 is elastically deformed such that the magnitude A₂ (A₂>A₁) of the contact area between the dome-shaped flexible switch 30 and the touch sensor array 32 is proportional with the magnitude F₂ of the normal pressure acting on the actuator 20 during the operation of the tapping device 10. In other words, a stronger pressure will squeeze on more of the dome-shaped flexible switch 30. This makes more contact on the touch sensor array 32. One advantage is that a simple-structure touch sensor array cannot distinguish the magnitude of pressure, but the dome-shaped flexible switch 30 of the present embodiment will push more the touch sensor array 32 when there is stronger normal pressure. This will help for an even tapping application to the skin surface 12, such as a face surface.

The touch sensor array 32 outputs a signal S₂ including the information about the magnitude A₂ of the contact area which is proportional with the magnitude F₂ of the pressure exerted on the actuator 20 during the operation of the tapping device 10.

The controller 26 determines the magnitude V₂ (V₂>V₁) of voltage to be applied to the direct-current motor 16 based on the information about the magnitude A₂ of the contact area obtained by the touch sensor array 32. The determined magnitude V₂ of voltage is proportional with the magnitude F₂ of the normal pressure exerted on the actuator 20 during the operation of the tapping device 10. The controller 26 applies the determined magnitude V₂ of voltage to the direct-current motor 16.

As a result, the direct-current motor 16 is driven at the applied magnitude V₂ of voltage. Accordingly, under a higher load condition shown in FIG. 2B, the direct-current motor 16 makes more power, compared with the lower load condition shown in FIG. 2A.

As described above, in the present embodiment, the magnitude of the pressure exerted on the actuator 20 is measured by the dome-shaped flexible switch 30 and the touch sensor array 32, during the operation of the tapping device 10 in real time.

Accordingly, even when the normal force exerted on the actuator 20 is largely changed during the operation of the tapping device 10, the magnitude of the change in the normal force on the actuator 20 can be accurately and rapidly obtained by the dome-shaped flexible switch 30 and the touch sensor array 32. In other words, even when the normal force exerted on the actuator 20 is changed from a case under the lower load condition as shown in FIG. 2A to a case under the higher load condition as shown in FIG. 2B, more power is given to the direct-current motor 16.

Therefore, even when the tapping device 10 of the present embodiment is driven at a lower speed, compared with the conventional tapping devices, a more appropriate tapping motion can be achieved, without stopping the tapping motion of the tapping applicator 14.

Whereby, since the tapping device 10 of the present embodiment can be reliably driven at a lower speed, the noise and vibration during the operation of the tapping device 10 can be largely reduced, and a more comfortable tapping motion can be provided to a user.

<Signal Processing>

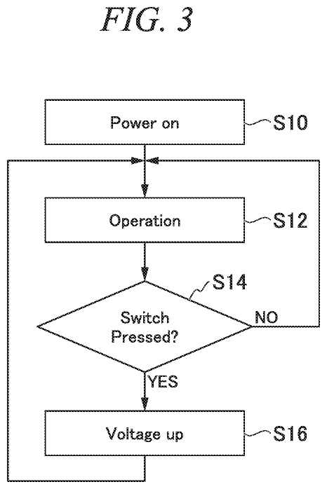

The signal process of the present embodiment will be described in detail below by referring to FIG. 3.

When the tapping device is powered on (S10), the operation of the tapping device is started (S12). For example, the direct-current motor is driven at a preset voltage.

When the tapping device is put on a skin surface of the user, the skin surface of the user is vertically tapped by the tapping applicator. In the present embodiment, during the operation of the tapping device in real time, the magnitude of normal pressure acting on the tapping applicator is measured by the dome-shaped flexible switch and the touch sensor array.

The magnitude of normal pressure measured by the touch sensor array is monitored by the controller during the operation of the tapping device in real time. For example, the controller determines whether or not the dome-shaped flexible switch is pressed against the touch sensor array (S14).

If the controller determines that the dome-shaped flexible switch is not pressed against the touch sensor array, the direct-current motor is driven at the preset voltage. If the controller determines that the dome-shaped flexible switch is pressed against the touch sensor array, the controller controls the magnitude of voltage applied to the direct-current motor so as to increase the magnitude of voltage applied to the direct-current motor (S16).

The signal from the touch sensor array is sent to the central processing unit controller (controller), and then the CPU (controller) converts the signal from the touch sensor array into a signal to control the magnitude of voltage of the direct-current motor. Therefore, a stronger pressure acting on the actuator will give a higher voltage to the direct-current motor, and eventually the stronger pressure will give more power to the direct-current motor.

Thus, an appropriate tapping motion can be performed without stopping the tapping motion of the tapping applicator, even when the normal pressure acting on the actuator is changed during the operation of the tapping device.

Accordingly, the tapping device of the present embodiment can be driven at a lower speed compared with conventional tapping devices. Therefore, noise and vibration during the operation of the tapping device of the present embodiment can be reduced, compared with conventional tapping devices.

The actuator does not make a lot of noise and vibration in a low RPM (revolution per minute) condition, but the noise and vibration is a greatly increased in a high RPM condition. Paradoxically, it is very hard to make enough torque in a low RPM condition, but the torque becomes high in a high RPM condition. Therefore, the noise and vibration can be reduced by controlling the speed of the direct-current motor to meet the load situation.

In the present embodiment, the direct-current motor rotates at low speed, but the torque is changed in real time based on the loading. A stronger pressure makes a higher feedback, and the higher feedback makes a higher signal to increase the voltage of the direct-current motor. The noise and vibration can be reduced because the direct-current motor RPM (revolution per minute) can maintain a low RPM. In conclusion, the direct-current motor RPM is kept at a low speed under a high load condition, and the users can feel an even tapping movement on an uneven face surface with less noise and vibration.

### Second Embodiment

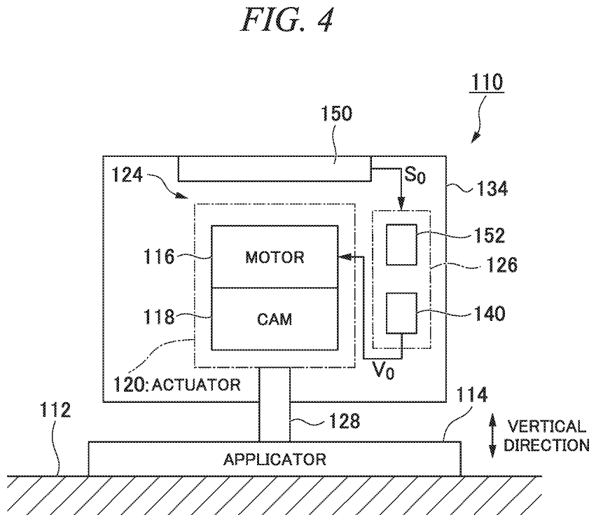

FIG. 4 shows a schematic structure of a tapping device according to a second embodiment of the present invention. Portions corresponding to those in FIG. 1 have the reference numeral 100 added thereto and a description will be omitted.

In the present embodiment, as the pressure sensing mechanism of the present invention, a piezo sensor 150 is used, instead of the dome-shaped switch and the touch sensor array.

In the tapping device 100 shown in FIG. 4, an amplifier 152 is provided. The voltage from the piezo sensor 150 is amplified by the amplifier 152.

In the tapping device 100 shown in FIG. 4, the piezo sensor 150 is attached to the inner wall of the outer case 134.

The piezo sensor 150 is pushed by the upper end of the actuator 120 in response to the normal pressure exerted on the actuator 120 during the operation of the tapping device 110.

When the piezo sensor 150 is pushed by the actuator 120, the piezo sensor 150 generates a voltage having a magnitude which is proportional with the magnitude of the applied force to the piezo sensor 150 by the actuator 120.

The controller 126 determines the magnitude of voltage to be applied to the direct-current motor 116 based on the information about the magnitude of voltage generated in the piezo sensor 150.

The direct-current motor 116 is driven at the applied magnitude of voltage by the controller 126.

In the present embodiment, since the piezo sensor 150 is used as the pressure sensing mechanism of the present invention, a more comfortable tapping motion can be provided to the user.

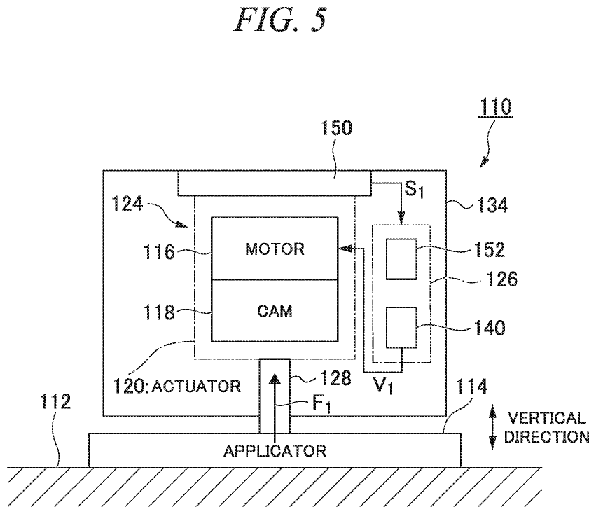

The pressure sensing mechanism of the present embodiment will be described in detail below by referring to FIGS. 4 and 5.

In the present embodiment, the actuator 120 is upwardly displaceable relative to the piezo sensor 150, due to the pressure exerted on the actuator 120 during the operation of the tapping device 110.

Under a lower load condition as shown in FIG. 4, since the piezo sensor 150 is not pressed by the actuator 120, the controller 126 keeps applying the preset voltage to the direct-current motor 116.

As shown in FIG. 5, when a user strongly pushes down the outer case 134 of the tapping device 110 against the skin surface 112 during the operation of the tapping device 110, a force F₁ from the skin surface 112 side is applied to the actuator 120 through the tapping applicator 114, the connecting shaft 128, and the cam structure 118, and eventually presses the piezo sensor 150 with the upper end of the actuator 120.

Under the higher load condition as shown in FIG. 5, the piezo sensor 150 generates a voltage having a magnitude which is proportional with the magnitude F₁ of the normal pressure acting on the actuator 120 during the operation of the tapping device 110.

The signal generated in the piezo sensor 150 is amplified by the amplifier 152 and sent to the controller 126. The controller 126 determines the magnitude V₁ of voltage to be applied to the direct-current motor 116 based on the information about the magnitude of voltage generated in the piezo sensor 150. The magnitude V₁ of voltage to be applied to the direct-current motor 116 is proportional with the magnitude F₁ of the normal pressure exerted on the actuator 120 during the operation of the tapping device 110.

The controller 126 applies the determined magnitude V₁ of voltage to the direct-current motor 116. As a result, the direct-current motor 116 is driven at the magnitude V₁ of voltage.

Thus, an appropriate tapping motion can be performed without stopping the tapping motion of the tapping applicator 114, even when the normal pressure acting on the actuator 120 is changed during the operation of the tapping device 110.

Accordingly, the tapping device 110 of the present embodiment can be driven at a lower speed compared with conventional tapping devices. Therefore, the noise and vibration during the operation of the tapping device 110 of the present embodiment can be reduced, compared with conventional tapping devices.

<Signal Processing>

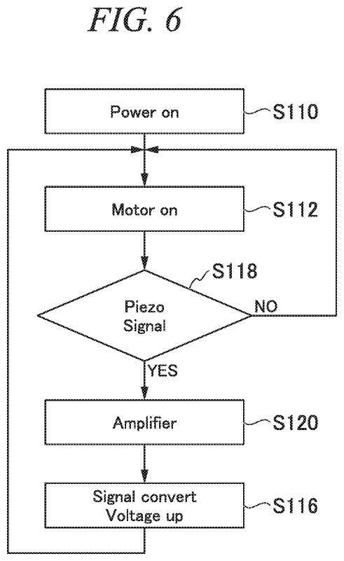

The signal processing of the present embodiment will be described in detail below by referring to FIG. 6. Portions corresponding to those in FIG. 3 have the reference numeral 100 added thereto and description will be omitted.

When the tapping device is put on a skin surface of a user, the skin surface of the user is vertically tapped by the tapping applicator.

In the present embodiment, during the operation of the tapping device in real time, normal pressure acting on the actuator is measured by the piezo sensor. The magnitude of normal pressure measured by the piezo sensor is monitored by the controller during the operation of the tapping device in real time. For example, the controller determines whether or not a signal (voltage) is generated in the piezo sensor (S118).

If the controller determines that the signal (voltage) is not generated in the piezo sensor, the direct-current motor is driven at the preset voltage. If the controller determines that the signal (voltage) is generated in the piezo sensor, the signal (voltage) from the piezo sensor is amplified by the amplifier (S120). Based on the signal amplified by the amplifier, the applied voltage to the direct-current motor is increased by the controller (S116).

As described above, even when the normal force exerted on the actuator is changed during the operation of the tapping device, an appropriate tapping motion can be performed without stopping the tapping motion of the tapping applicator.

Therefore, the tapping device of the present embodiment can be driven at a lower speed, compared with conventional tapping devices. Whereby the noise and vibration during the operation of the tapping device of the present embodiment can be reduced compared with conventional tapping devices.

### Third Embodiment

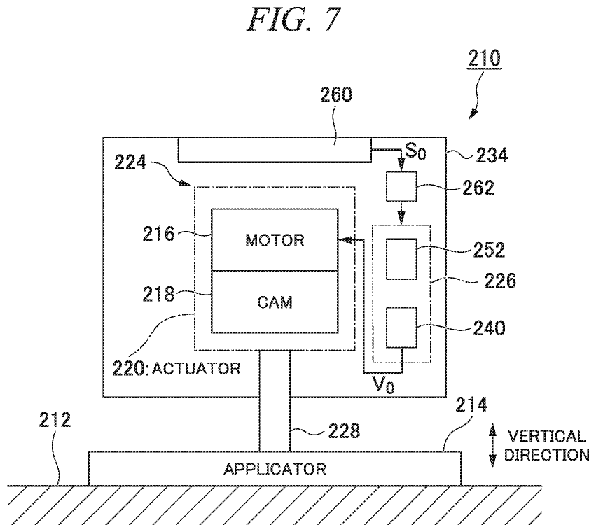

In the second embodiment, the piezo sensor is used as the pressure sensing mechanism of the present invention. However, the present invention is not limited to this case. The present invention is suitably applied, for example, to a case in which a conductive material body is used, as shown in FIG. 7.

FIG. 7 shows a schematic structure of a tapping device according to a third embodiment of the present invention. Portions corresponding to those in FIG. 4 have the reference numeral 100 added thereto and a description will be omitted.

In the present embodiment, a conductive material body 260 and an extractor 262 are used as the pressure sensing mechanism, instead of the piezo sensor.

In the present embodiment, the conductive material body 260 is a conductive sponge or a conductive microgel rubber. The conductive sponge may be a sponge in which carbon is dispersed. The conductive microgel rubber may be a microgel rubber in which carbon is dispersed.

The actuator 220 pushes the conductive material body 260 in response to the normal pressure exerted on the actuator 220 during the operation of the tapping device 210. The extractor 262 obtains the information about the magnitude of density of the conductive material body 260.

In other words, the conductive material body 260 elastically deforms such that the magnitude of density of the conductive material body 260 is proportional with the magnitude of normal pressure exerted on the actuator 220 during the operation of the tapping device 210.

Accordingly, the controller 226 determines the applied magnitude of voltage to the direct-current motor 216 based on the information about the magnitude of density obtained by the extractor 262.

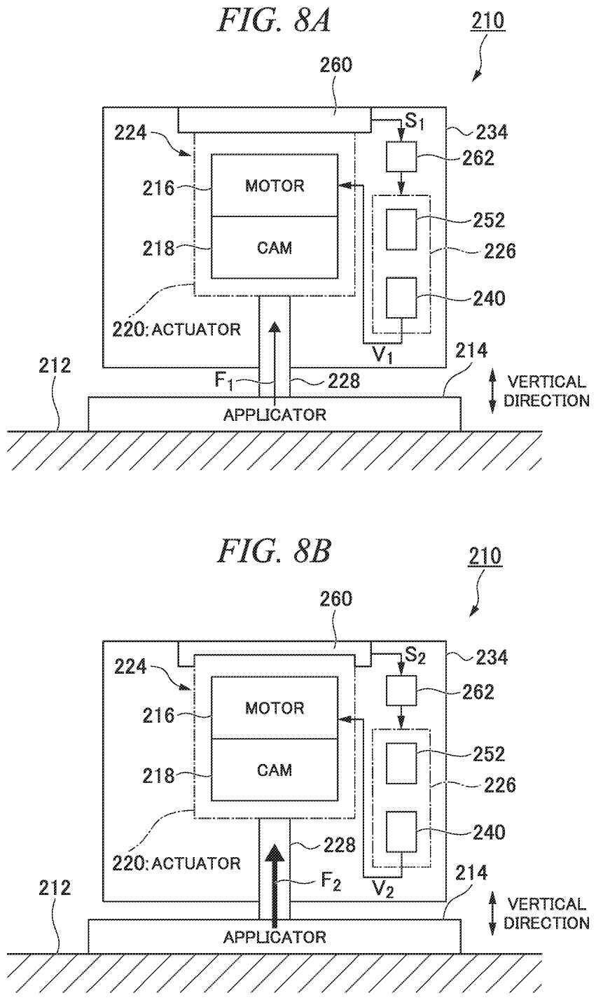

The pressure sensing mechanism of the present embodiment will be described in detail below by referring to FIGS. 8A and 8B. In the present embodiment, the actuator 220 is movable in the vertical direction in the outer case 234. Accordingly, when a user slightly pushes down the outer case 234 of the tapping device 210 against the skin surface 212 during the operation of the tapping device 210, as shown in FIG. 8A, a force F₁ from the skin surface 212 side is applied to the actuator 220 through the tapping applicator 214, the connecting shaft 228, and the cam structure 218, and eventually slightly presses the conductive material body 260 with the upper end of the actuator 220.

Under a lower load condition as shown in FIG. 8A, the conductive material body 260 is elastically deformed such that the magnitude D₁ of density of the conductive material body 260 is proportional with the magnitude F₁ of the normal pressure exerted on the actuator 220 during the operation of the tapping device 210. The extractor 262 obtains the information about the magnitude D₁ of density of the conductive material body 260 and outputs a signal S₁ including the information about the magnitude D₁ of density of the conductive material body 260.

The controller 226 determines the magnitude V₁ of voltage to be applied to the direct-current motor 216 based on the information about the magnitude D₁ of density obtained by the extractor 262. The magnitude V₁ of voltage to be applied to the direct-current motor 216 is proportional with the magnitude of normal pressure exerted on the actuator 220 during the operation of the tapping device 210. The controller 226 applies the determined magnitude V₁ of voltage to the direct-current motor 216. As a result, the direct-current motor 216 is driven at the applied magnitude V₁ of voltage.

As shown in FIG. 8B, when the user strongly pushes down the outer case 234 of the tapping device 210 against the skin surface 212 during the operation of the tapping device 210, a force F₂ from the skin surface 212 side is applied to the actuator 220 through the tapping applicator 214, the connecting shaft 228, and the cam structure 218. The force F₂ eventually strongly presses the conductive material body 260 with the upper end of the actuator 220.

Under a higher load condition as shown in FIG. 8B, the conductive material body 260 is elastically deformed such that the magnitude D₂ (D₂>D₁) of density of the conductive material body 260 is proportional with the magnitude F₂ of the normal pressure exerted on the actuator 220 during the operation of the tapping device 210.

The extractor 262 obtains the information about the magnitude D₂ of density of the conductive material body 260 and outputs a signal S₂ including the information about the magnitude D₂ of density of the conductive material body 260.

The controller 226 determines the magnitude V₂ (V₂>V₁) of voltage to be applied to the direct-current motor 216 based on the information about the magnitude D₂ of the density of the conductive material body 260. The magnitude V₂ of voltage is proportional with the magnitude F₂ of the normal pressure exerted on the actuator 220 during the operation of the tapping device 210. The controller 226 applies the determined magnitude V₂ (V₂>V₁) of voltage to the direct-current motor 216. As a result, the direct-current motor 216 is driven at the applied magnitude V₂ of voltage. Accordingly, under a higher load condition shown in FIG. 8B, the direct-current motor 216 generates a more power, compared with the lower load condition shown in FIG. 8A.

As described above, in the present embodiment, the magnitude of the pressure exerted on the actuator 220 is measured by the conductive material body 260 and the extractor 262 during the operation of the tapping device 10 in real time.

Accordingly, even when the normal force exerted on the actuator 220 is largely changed during the operation of the tapping device 210, the magnitude of the change in the normal force on the actuator 220 can be accurately and rapidly obtained by the conductive material body 260 and the extractor 262. In other words, even when the normal force exerted on the actuator 220 is changed from a case under the lower load condition as shown in FIG. 8A to a case under the higher load condition as shown in FIG. 8B, more power is given to the direct-current motor 216.

Therefore, even when the tapping device 210 of the present embodiment is driven at a lower speed, compared with the conventional tapping devices, a more appropriate tapping motion can be achieved, without stopping the tapping motion of the tapping applicator 214.

Whereby, since the tapping device 210 of the present embodiment can be reliably driven at a lower speed, a noise and vibration during the operation of the tapping device 210 can be largely reduced, and a more comfortable tapping motion can be provided to a user.

<Cam Structure>

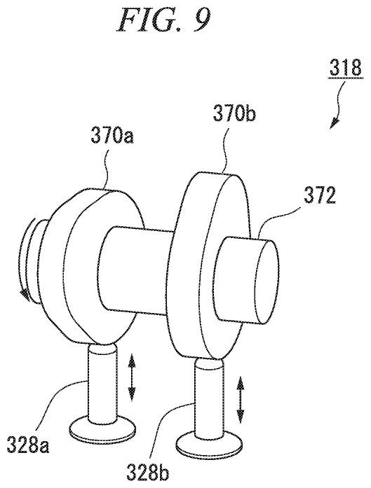

To provide a more comfortable tapping, it is preferred for the actuator in accordance with the present embodiments to be provided with a cam structure shown in FIG. 9. Portions corresponding to those in FIG. 1 have the reference numeral 300 added thereto and a description will be omitted. The cam structure 318 shown in FIG. 9 comprises cams 370a and 370b. The cams 370a and 370b are provided between the output shaft 372 of the direct-current motor and the connecting shafts 328a and 328b of the tapping device.

The rotation motion of the direct-current motor can be transferred to the liner motion of the connecting shafts 328a and 328b, via output shaft 372 of the direct-current motor and the cams 370a and 370b. Therefore, the tapping motion of the tapping applicator connected to the connecting shafts 328a and 328b can be effectively performed by using the cam structure 318 shown in FIG. 9.

<Advantages of the Present Embodiments>

As described above, according to the tapping devices of the present embodiments, since the force sensing mechanisms to provide real time speed modulation are used, the following advantages are obtained.

Even sensation in a various bumps on the face can be delivered;

the stopping of the tapping motion can be prevented even when user push the tapping device too much; and

a silent and mild touch on the soft tissue can be given.

1. A tapping device for vertically tapping a skin surface comprising:
a tapping applicator for applying a normal force on the skin surface, wherein the tapping applicator is reciprocated in a direction substantially perpendicular to the skin surface;
an actuator for generating the linear reciprocating motion of the tapping applicator, wherein the actuator comprises a direct-current motor which is driven at an applied magnitude of voltage;
a pressure sensing mechanism for measuring the magnitude of normal pressure exerted on the actuator during the operation of the tapping device in real time; and
a controller for controlling the magnitude of voltage to be applied to the direct-current motor in real time, wherein the applied magnitude of voltage corresponds to the magnitude of normal pressure measured by the pressure sensing mechanism.

2. The tapping device according to claim 1, wherein the controller controls the rotational speed of the direct-current motor such that the rotational speed of the direct-current motor is kept between 500 rpm to 3,000 rpm during the operation of the tapping device.

3. The tapping device according to claim 1, further comprising a case for housing the actuator and the pressure sensing mechanism,
wherein the actuator and the pressure sensing mechanism are vertically placed face to face each other in the case, and
wherein the actuator is relatively displaceable in the case in the vertical direction, in response to the normal pressure exerted on the actuator in the case during the operation of the tapping device.

4. The tapping device according to claim 3, wherein the pressure sensing mechanism comprises a flexible switch and a touch sensor array,
wherein the flexible switch is attached to the actuator so as to be relatively displaceable together with the actuator,
wherein the touch sensor array is attached to the case,
wherein the flexible switch and the touch sensor array are vertically placed face to face each other in the case, such that the flexible switch and the actuator approach each other or move away from each other in response to the normal pressure exerted on the actuator during the operation of the tapping device,
wherein the flexible switch makes contact with the touch sensor array such that the magnitude of the contact area between the flexible switch and the touch sensor array corresponds to the magnitude of normal pressure exerted on the actuator during the operation of the tapping device, and
wherein the controller determines the magnitude of voltage to be applied to the direct-current motor based on the information about the magnitude of the contact area obtained by touch sensor array, and the controller applies the determined magnitude of voltage to the direct-current motor.

5. The tapping device according to claim 4, wherein the flexible switch is a dome-shaped flexible switch, and
wherein the dome-shaped flexible switch makes an elastic deformation such that the magnitude of the contact area between the dome-shaped flexible switch and the touch sensor array corresponds to the magnitude of normal pressure exerted on the actuator during the operation of the tapping device.

6. The tapping device according to claim 3, wherein the pressure sensing mechanism comprises a pressure sensor, and
wherein the pressure sensor is pushed by the actuator in response to the normal pressure exerted on the actuator during the operation of the tapping device.

7. The tapping device according to claim 6, wherein the pressure sensor comprises a piezo sensor.

8. The tapping device according to claim 3, wherein the pressure sensing mechanism comprises a conductive material body which elastically deforms, and an extractor,
wherein the conductive material body is pushed by the actuator in response to the pressure exerted on the actuator during the operation of the tapping device, and the conductive material body elastically deforms such that the magnitude of density of the conductive material body correspond to the magnitude of pressure exerted on the actuator during the operation of the tapping device,
wherein the extractor obtains the information about the magnitude of density of the conductive material body, and
wherein the controller determines the magnitude of voltage to be applied to the direct-current motor based on the information about the magnitude of density of the conductive material body obtained by the extractor, and the controller applies the determined magnitude of voltage to the direct-current motor.

9. The tapping device according to claim 8, wherein the conductive material body is a conductive sponge or a conductive microgel rubber.

10. The tapping device according to claim 1, wherein the actuator further comprises a cam structure, and
wherein the tapping device further comprises a connecting shaft which is provided between the tapping applicator and the cam structure, such that the rotary motion of the direct-current motor is converted into the linear reciprocating motion of the connecting shaft via the cam structure.
